(19) United States
(12) Patent Application Publication
(10) Pub. No.: US 2026/0208076 A1
(43) Pub. Date: Jul. 23, 2026

(54) LIQUID FILTER HEAD ADAPTOR

(71) Applicant: Cummins Filtration Inc., Nashville, TN (US)

(72) Inventors: Justin Miles, Cookeville, TN (US); Samuel Miller, Cookeville, TN (US); Ismail Bagci, Cookeville, TN (US)

(73) Assignee: Cummins Filtration Inc., Nashville, TN (US)

(21) Appl. No.: 19/032,943

(22) Filed: Jan. 21, 2025

(51) Int. Cl. B01D 35/30

(52) U.S. Cl. CPC B01D 35/30; B01D 2201/302; B01D 2201/304

(57) ABSTRACT

A filter head adapter includes an endplate. The filter head adapter includes a central conduit comprising a first portion and a second portion. The first portion extends in a first direction from the endplate and a second portion extends in a second direction from the endplate. The filter head adapter includes an outer wall extending from an edge of the endplate in the first direction. The outer wall includes a first threaded portion. The filter head adapter includes an inner wall extending from the endplate in the first direction. The inner wall includes a second threaded portion. The outer wall and the endplate define a cavity. The inner wall is positioned in the cavity between the outer wall and the first portion of the central conduit.

The present disclosure relates generally to filters for use with internal combustion engine systems.

### BACKGROUND

Filtration assemblies may be used to filter liquids to protect downstream devices from corrosion. For example, the filtration assembly can be a fuel water separator configured to separate water from fuel to protect downstream devices from corrosion. Filtration assemblies may further protect downstream devices by including filter elements to separate impurities from the fuel that may damage the downstream devices. However, filtration assemblies can come in various forms such that only certain assemblies can connect with certain systems.

### SUMMARY

Embodiments described herein relate generally to filter head adapters that can connect different filter assemblies to an engine system.

In some embodiments, a filter head adapter includes an endplate. The filter head adapter includes a central conduit comprising a first portion and a second portion. The first portion extends in a first direction from the endplate and a second portion extends in a second direction from the endplate. The filter head adapter includes an outer wall extending from an edge of the endplate in the first direction. The outer wall includes a first threaded portion. The filter head adapter includes an inner wall extending from the endplate in the first direction. The inner wall includes a second threaded portion. The outer wall and the endplate define a cavity. The inner wall is positioned in the cavity between the outer wall and the first portion of the central conduit.

In some embodiments, a filter head adapter includes an endplate. The filter head adapter includes an outer wall extending from an edge of the endplate in a first direction. The outer wall includes a first threaded portion. The endplate and the outer wall define a cavity. The filter head adapter includes a central protrusion extending from the endplate in the first direction into the cavity. The central protrusion includes a second threaded portion. And an internal installation element configured to facilitate installation of the filter head adapter with a filter head. The filter head adapter includes an outer projection extending from the endplate in a second direction. The central protrusion, the endplate, and the outer projection define a central conduit that extends therethrough.

In some embodiments, a filter head adapter includes an endplate. The filter head adapter includes an outer wall extending from an edge of the endplate in a first direction. The outer wall includes a threaded portion. The endplate and the outer wall define a cavity. The filter head adapter includes a central protrusion extending from the endplate in the first direction into the cavity. The central protrusion includes a first connection element configured to couple with a first conduit. The filter head adapter includes an offset protrusion extending from the endplate in the first direction into the cavity. The offset protrusion includes a second connection element configured to couple with a second conduit. The filter head adapter includes an outer projection extending from the endplate in a second direction. The central protrusion, the endplate, and the outer projection define a central conduit extending therethrough.

In some embodiments, a system includes a filter head, a filter head adapter, and a filter element. The filter head adapter includes an endplate. The filter head adapter includes a central conduit comprising a first portion and a second portion. The first portion extends in a first direction from the endplate and a second portion extends in a second direction from the endplate. The filter head adapter includes an outer wall extending from an edge of the endplate in the first direction. The outer wall includes a first threaded portion. The filter head adapter includes an inner wall extending from the endplate in the first direction. The inner wall includes a second threaded portion. The outer wall and the endplate define a cavity. The inner wall is positioned in the cavity between the outer wall and the first portion of the central conduit.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a perspective view of an engine system, according to an example embodiment.

FIG. 2 is a cross-sectional view of a portion of the engine system of FIG. 1.

FIG. 3 is a bottom perspective view of a filter head adapter of the engine system of FIG. 1.

FIG. 4 is a perspective view of an engine system, according to an example embodiment.

FIG. 5 is a cross-sectional view of a portion of the engine system of FIG. 4.

FIG. 6 is a bottom perspective view of a filter head adapter of the engine system of FIG. 4.

FIG. 7 is a top perspective view of a filter head adapter of the engine system of FIG. 4, according to an example embodiment.

FIG. 8 is a perspective view of an engine system, according to an example embodiment.

FIG. 9 is a cross-sectional view of a portion of the engine system of FIG. 8.

FIG. 10 is a flow diagram of a method for installing a filter element, according to an example embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein generally related to filter head adapters configured to couple with a filter head to enable various filter elements to couple with an engine system. The various embodiments of filter head adapters include both local and remote connection options for the various filter elements.

Referring to the figures generally, various filter head adapters are described. The described filter head adapters can allow different filter elements to couple with an engine system, which can provide different filtering capabilities for the engine system. For example, instead of having a filter element couple directly with the engine system, and therefore requiring a specific connector that corresponds to the filter head, the adapter has a first connector that corresponds with the filter head and a second connector that corresponds with a filter element. A different filter head adapter can be used based on which filter element is to be coupled with the engine system.

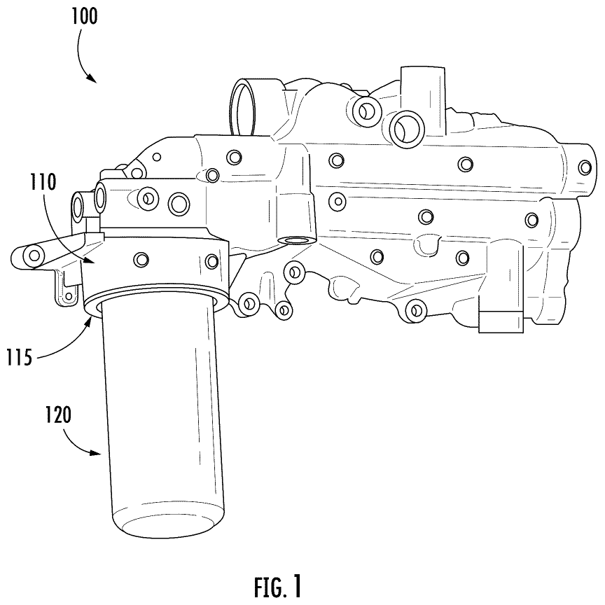

Referring to FIG. 1, an engine system 100 is shown, according to an example embodiment. The engine system 100 includes an engine (not shown). The engine can be an engine of a vehicle (e.g., car, truck, construction vehicle). The engine includes a filter head 110. The filter head 110 is configured to couple to a filter element with the engine. The engine system 100 includes a filter head adapter 115. The filter head adapter 115 couples with the engine via the filter head 110. The filter head adapter 115 provides a connection point for a filter element. The engine system 100 includes a filter element 120. The filter element 120 is configured to couple with the engine via the filter head adapter 115.

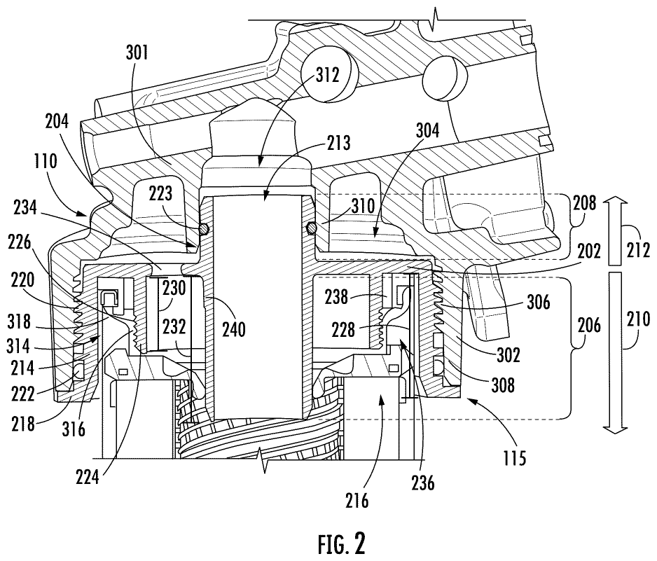

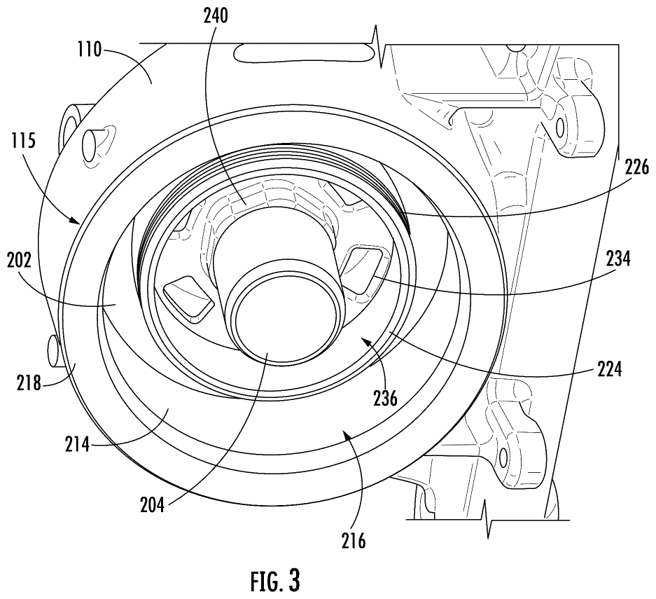

Referring to FIGS. 2 and 3, a filter head adapter 115 is shown, according to an example embodiment. The filter head adapter 115 is configured to couple with the filter head 110. The filter head adapter 115 includes an endplate 202. The endplate 202 has an annular (e.g., disk) shape.

The filter head adapter 115 includes a central conduit 204. The central conduit 204 includes a first portion 206 and a second portion 208. The first portion 206 extends axially away from the endplate 202 in a first direction 210. The second portion 208 extends axially away from the endplate 202 in a second direction 212 The first direction 210 is substantially opposite the second direction 212. The central conduit 204 defines a conduit cavity 213 that extends axially through a center of the endplate 202.

The filter head adapter 115 includes an outer wall 214. The outer wall 214 extends from an edge of the endplate 202 in the first direction 210. The outer wall 214 extends axially away from the endplate 202 at the edge of the endplate 202. The outer wall 214 extends along the entire edge (e.g., perimeter) of the endplate 202. The outer wall 214 and the endplate 202 define a cavity, shown as adapter cavity 216. The filter head adapter 115 includes a flange 218. The flange 218 is positioned at an end of the outer wall 214, opposite the endplate 202. The flange 218 extends radially outward from the end of the outer wall 214 (e.g., away from the central conduit 204).

The outer wall 214 includes an outer threaded portion 220 comprising a plurality of threads. The outer threaded portion 220 is radially outwardly facing such that the threads extend radially outward from the outer wall 214. The outer threaded portion 220 is radially external to (e.g., positioned outside of) the adapter cavity 216.

The outer threaded portion 220 is configured to couple the filter head adapter 115 with the filter head 110. For example, the filter head 110 includes a head body 301. The filter head 110 includes an outer head wall 302. The outer head wall 302 extends axially from the head body 301. The head body 301 and the outer head wall 302 define a head cavity 304. The outer head wall 302 defines at least a portion of a side of the head cavity 304. The outer head wall 302 includes a threaded head portion 306. The threaded head portion 306 is configured to engage with the outer threaded portion 220 of the outer wall 214 to couple the filter head adapter 115 with the filter head 110. For example, the threaded head portion 306 is positioned on an inner surface of the outer head wall 302. The threaded head portion 306 includes a plurality of threads that extend radially inward from the outer head wall 302 into the head cavity 304. The threaded head portion 306 engages with the outer threaded portion 220 to couple the filter head adapter 115 with the filter head 110.

The outer wall 214 includes a wall seal element 222. The wall seal element 222 is positioned on the outer wall 214. The wall seal element 222 is configured to form a radially outwardly directed seal with the filter head 110. For example, the outer head wall 302 of the filter head 110 includes a flat portion 308. The flat portion 308 is positioned axially away from the head body 301. For example, the threaded head portion 306 is positioned axially between the flat portion 308 and the head body 301. The wall seal element 222 is configured to interface with the flat portion 308 of the outer head wall 302 to form a radial seal.

The wall seal element 222 is radially external to (e.g., positioned outside of) the adapter cavity 216. The wall seal element 222 is positioned axially between the outer threaded portion 220 and the flange 218. For example, the outer threaded portion 220 is positioned along the outer wall 214 closer to the endplate 202 than the wall seal element 222. In some embodiments, the wall seal element 222 includes a gasket (e.g., an O-ring).

The central conduit 204 includes a seal element, shown as conduit seal element 223. The conduit seal element 223 is positioned on the second portion 208 of the central conduit 204. The conduit seal element 223 is configured to form a seal with the filter head 110. For example, the filter head 110 includes an inner head wall 310. The inner head wall 310 extends axially from the head body 301 into the head cavity 304. The inner head wall 310 defines an inner head cavity 312. The second portion 208 of the central conduit 204 can be positioned in the inner head cavity 312. The conduit seal element 223 is configured to interface with an inner surface of the inner head wall 310 to form a radial seal. The wall seal element 222 can form a first seal with the filter head 110 and the conduit seal element 223 can form a second seal with the filter head 110.

The filter head adapter 115 includes an inner wall 224. The inner wall 224 extends axially away from the endplate 202 in the first direction 210. The inner wall 224 is positioned in the adapter cavity 216. For example, the inner wall 224 is positioned radially between the outer wall 214 and the first portion 206 of the central conduit 204.

The inner wall 224 includes a threaded portion, shown as inner threaded portion 226, comprising a plurality of threads. The inner threaded portion 226 is radially outwardly facing such that the threads are extending radially outward from the inner wall 224. The inner threaded portion 226 is internal to (e.g., positioned inside of) the adapter cavity 216. In some embodiments, the inner threaded portion 226 is positioned proximate an end of the inner wall 224, away from the endplate 202.

The inner threaded portion 226 is configured to couple the filter element 120 with the filter head adapter 115. For example, the filter element 120 includes a filter projection 314. The filter projection 314 can extend from an end of the filter element 120. The filter projection 314 includes a threaded filter portion 316. The threaded filter portion 316 is configured to engage the inner threaded portion 226 to couple the filter element 120 with the filter head adapter 115.

The outer wall 214 has a first length, shown as outer wall length 228. The inner wall 224 has a second length, shown as inner wall length 230. The first portion 206 of the central conduit 204 has a third length, shown as conduit length 232. In some embodiments, the outer wall length 228 can be greater than the inner wall length 230. In other embodiments, the outer wall length 228 can be less than or the same as the inner wall length 230. In some embodiments, the conduit length 232 can be greater than the outer wall length 228 and the inner wall length 230. In other embodiments, the conduit length 232 can be less than the outer wall length 228 and the inner wall length 230, between the outer wall length 228 and the inner wall length 230, or the same as at least one of the outer wall length 228 or the inner wall length 230.

The filter head adapter 115 includes at least one aperture 234, as shown in FIG. 3. For example, the endplate 202 defines an aperture 234 that extends therethrough. The aperture 234 is positioned radially between the central conduit 204 and the inner wall 224. The filter head adapter 115 is configured to receive a fluid via the aperture 234. The filter head adapter 115 is configured to expel a filter fluid via the central conduit 204.

The filter head adapter 115 can include a plurality of the apertures 234. For example, the endplate 202 defines a plurality of apertures 234 that extend therethrough. The apertures 234 can be positioned radially around the central conduit 204. The apertures 234 can be evenly spaced around the central conduit 204. Each of the apertures 234 can be configured to receive a fluid to enter the adapter cavity 216.

The filter head adapter 115 includes a wall cavity 236. For example, the outer wall 214 and the inner wall 224 define a wall cavity 236. The filter head adapter 115 includes a seal member 238. The seal member 238 is positioned in the wall cavity 236. The seal member 238 interfaces with or abuts the endplate 202. The seal member 238 is configured to form an axially directed seal between the filter head adapter 115 and a filter element 120 coupled with the filter head adapter 115. For example, the filter projection 314 of the filter element 120 can include a filter seal element 318. At least a portion of the filter projection 314 can be positioned in the wall cavity 236 when the filter element 120 is coupled with the filter head adapter 115. With the filter projection 314 positioned in the wall cavity 236, the filter seal element 318 is positioned in the wall cavity 236 to interface with the seal member 238. The filter seal element 318 and the seal member 238 can form an axially directed seal between the filter element 120 and the endplate 202 of the filter head adapter 115. In some embodiments, the seal member 238 can interface with or abut at least one of the outer wall 228 or the inner wall 224 to form a radially directed seal in the wall cavity 236.

The filter head adapter 115 includes an installation element 240. The installation element 240 is positioned at a base of the first portion 206 of the central conduit 204. For example, the installation element 240 is positioned adjacent to the endplate 202. The installation element 240 is configured to facilitate installation of the filter head adapter 115 with an filter head 110. The installation element 240 can have a specific shape. For example, the installation element 240 can have a hexagonal shape. A tool can have a feature that corresponds to the installation element 240 to allow the tool to grip the filter head adapter 115 to couple the filter head adapter 115 with the filter head 110.

In some embodiments, the installation element 240 can be radially external to the central conduit 204. For example, the installation element 240 can extend radially outward from the central conduit 204 and extend around the central conduit 204. In some embodiments, the installation element 240 can be radially internal to the central conduit 204. For example, the installation element 240 can be positioned in the conduit cavity 213 and extend radially inward from the central conduit 204.

The installation element 240 can have any shape. For example, the installation element 240 can have a hexagonal shape. The installation element 240 can be an external hexagon (e.g., radially outside the central conduit 204) or an internal hexagon (e.g., radially inside the central conduit 204).

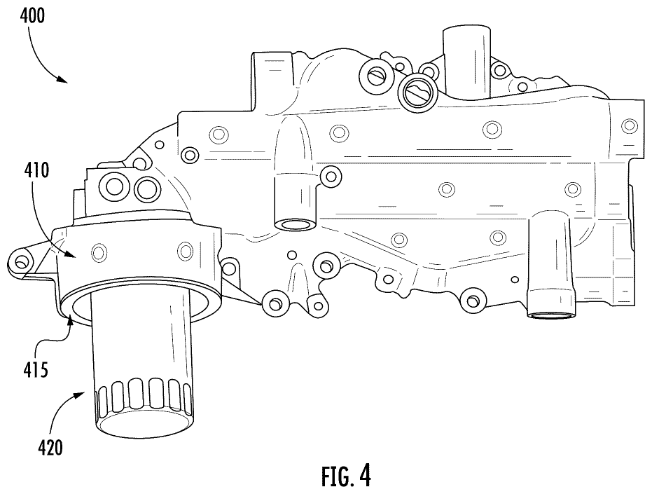

Referring to FIG. 4, an engine system 400 is shown, according to another example embodiment. The engine system 400 includes an engine (not shown). The engine can be an engine of a vehicle (e.g., car, truck, construction vehicle). The engine includes a filter head 410. The filter head 410 is configured to couple a filter element with the engine. The engine system 400 includes a filter head adapter 415. The filter head adapter 415 couples with the engine via the filter head 410. The filter head adapter 415 provides a connection point for a filter element. The engine system 400 includes a filter element 420. The filter element 420 is configured to couple with the engine via the filter head adapter 415.

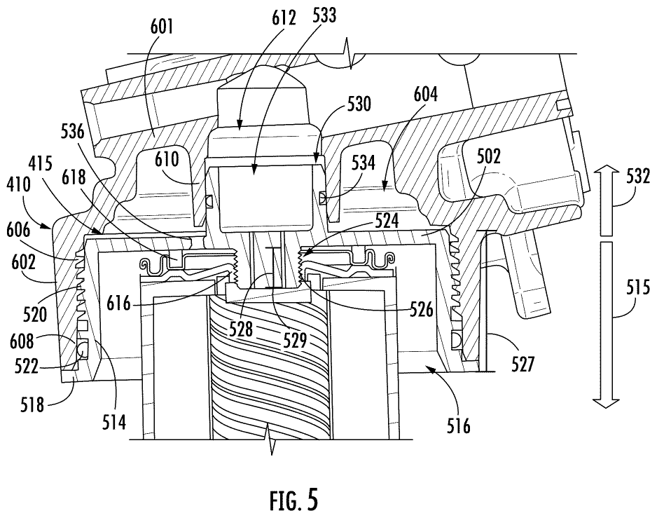

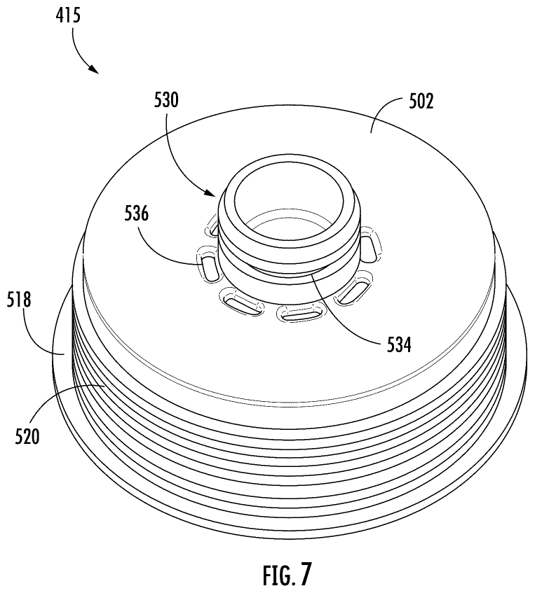

Referring to FIGS. 5-7, a filter head adapter 415 is shown, according to an example embodiment. The filter head adapter 415 is configured to couple with the filter head 410. The filter head adapter 415 includes an endplate 502. The endplate 502 has an annular (e.g., disk) shape.

The filter head adapter 415 includes an outer wall 514. The outer wall 514 extends from an edge of the endplate 502 in a first direction 515. The outer wall 514 extends axially away from the endplate 502 at the edge of the endplate 502. The outer wall 514 extends along the entire edge (e.g., perimeter) of the endplate 502. The outer wall 514 and the endplate 502 define a cavity, shown as adapter cavity 516. The filter head adapter 415 includes a flange 518. The flange 518 is positioned at an end of the outer wall 514, opposite the endplate 502. The flange 518 extends radially outward from the end of the outer wall 514 (e.g., away from the adapter cavity 516).

The outer wall 514 includes a threaded portion, shown as outer threaded portion 520 comprising a plurality of threads. The outer threaded portion 520 is radially outwardly facing such that the threads are extending radially outward from the outer wall 514. The outer threaded portion 520 is radially external to (e.g., positioned outside of) the adapter cavity 516.

The outer threaded portion 520 is configured to couple the filter head adapter 415 with the filter head 410. For example, the filter head 410 comprises a head body 601. The filter head 410 includes an outer head wall 602. The outer head wall 602 extends axially from the head body 601. The head body 601 and the outer head wall 602 define a head cavity 604. The outer head wall 602 defines at least a portion of a side of the head cavity 604. The outer head wall 602 includes a threaded head portion 606. The threaded head portion 606 is configured to engage with the outer threaded portion 520 of the outer wall 514 to couple the filter head adapter 415 with the filter head 410. For example, the threaded head portion 606 is positioned on an inner surface of the outer head wall 602. The threaded head portion 606 includes a plurality of threads that extend radially inward from the outer head wall 602 into the head cavity 604. The threaded head portion 606 engages with the outer threaded portion 520 to couple the filter head adapter 415 with the filter head 410.

The outer wall 514 includes a seal element, shown as wall seal element 522. The wall seal element 522 is positioned on the outer wall 514. The wall seal element 522 is configured to form a radially outwardly directed seal with the filter head 410. For example, the outer head wall 602 of the filter head 410 includes a flat portion 608. The flat portion 608 is positioned axially away from the head body 601. For example, the threaded head portion 606 is positioned axially between the flat portion 608 and the head body 601. The wall seal element 522 is configured to interface with the flat portion 608 of the outer head wall 602 to form a radial seal.

The wall seal element 522 is radially external to (e.g., positioned outside of) the adapter cavity 516. The wall seal element 522 is positioned axially between the outer threaded portion 520 and the flange 518. For example, the outer threaded portion 520 is positioned along the outer wall 514 closer to the endplate 502 than the wall seal element 522. In some embodiments, the wall seal element 522 includes a gasket (e.g., an O-ring).

The filter head adapter 415 includes a central protrusion 524. The central protrusion 524 extends axially away from the endplate 502 in the first direction 515. For example, the central protrusion 524 extends axially into the adapter cavity 516.

The central protrusion 524 includes a threaded portion, shown as inner threaded portion 526, comprising a plurality of threads. The inner threaded portion 526 is external to (e.g., positioned outside of) the central protrusion 524. For example, the inner threaded portion 526 is radially outwardly facing such that the threads extend radially outward from an outer surface of the central protrusion 524 into the adapter cavity 516.

The inner threaded portion 526 is configured to couple a filter element 420 with the filter head adapter 415. For example, the filter element 420 has a corresponding threaded portion, shown as threaded filter portion 616, configured to interface with the inner threaded portion 526 to couple the filter element 420 with the filter head adapter 415.

With the filter element 420 coupled with the filter head adapter 415, the filter element 420 can create an axial seal against the endplate 502 of the filter head adapter 415. For example, the filter element 420 can include a filter seal element 618. The filter seal element 618 can interface with the endplate 502 to form an axially directed seal between the filter element 420 and the filter head adapter 415. The filter seal element 618 can extend around the central protrusion 524. For example, the filter seal element 618 can be positioned in the adapter cavity 516, between the central protrusion 524 and the outer wall 514 when the filter element 420 is coupled with the filter head adapter 415.

The outer wall 514 has a first length, shown as outer wall length 527. The central protrusion 524 has a second length, shown as protrusion length 528. In some embodiments, the outer wall length 527 can be greater than the protrusion length 528. In other embodiments, the outer wall length 527 can be less than or the same as the protrusion length 528.

The filter head adapter 415 includes an installation element 529. The installation element 529 is configured to facilitate installation of the filter head adapter 415 with a filter head 410. The installation element 529 is a part of the central protrusion 524. For example, the installation element 529 can define a cavity that extends at least partially axially through the central protrusion 524. The cavity can be the installation element 529. For example, the installation element 529 or cavity can have a specific shape. A tool can have a feature that corresponds to the installation element 529 to allow the tool to grip the filter head adapter 415 to couple the filter head adapter 415 with the filter head 410. The installation element 529 can have any shape. For example, the installation element 529 can have a square shape such that the cavity of the central protrusion 524 has a square cross-sectional shape.

The filter head adapter 415 includes an outer projection 530. The outer projection 530 extends axially away from the endplate 502 in a second direction 532. The second direction 532 is opposite the first direction 515 of the central protrusion 524. The outer projection 530 has a diameter that is greater than a diameter of the central protrusion 524.

The central protrusion 524, the endplate 502, and the outer projection 530 define a central conduit 533 that extends therethrough. The central conduit 533 has a first portion with a first diameter or cross-sectional area that extends axially through the outer projection 530 and a second portion with a second diameter or cross-sectional area that extends axially through the endplate 502 and the central protrusion 524. The first diameter or cross-sectional area is greater than the second diameter or cross-sectional area. The second portion of the central conduit 533 can be or include the installation element 529. For example, a shape of the second portion of the central conduit 533 can correspond with a shape of a tool configured to help couple the filter head adapter 415 with the filter head 410.

The outer projection 530 includes a seal element, shown as projection seal element 534. The projection seal element 534 is positioned on an outer surface of the outer projection 530. The projection seal element 534 is configured to form a radially outwardly directed seal with the filter head 410. For example, the filter head 410 includes an inner head wall 610. The inner head wall 610 extends axially from the head body 601 into the head cavity 604. The inner head wall 610 defines an inner head cavity 612. The outer projection 530 can be positioned in the inner head cavity 612. The projection seal element 534 is configured to interface with an inner surface of the inner head wall 610 to form a radial seal. The wall seal element 522 can form a first seal with the filter head 410 and the projection seal element 534 can form a second seal with the filter head 410.

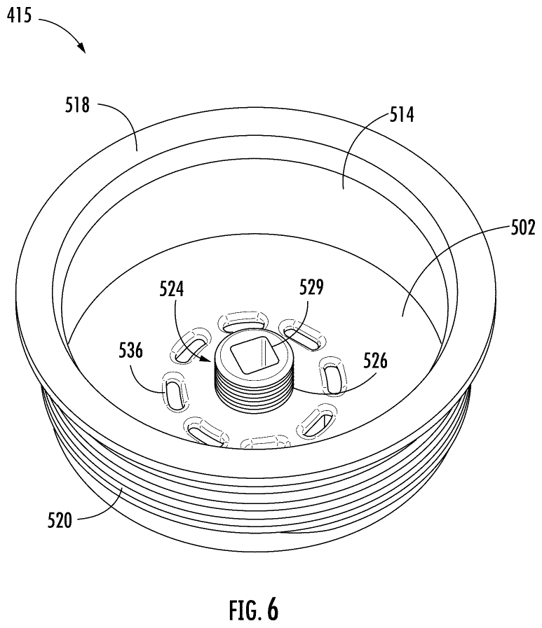

The filter head adapter 415 includes at least one aperture 536, as shown in FIG. 6. For example, the endplate 502 defines an aperture 536 that extends therethrough. The aperture 536 is positioned radially between the outer projection 530 and the outer wall 514. The filter head adapter 415 is configured to receive a fluid via the aperture 536. The filter head adapter 415 is configured to expel a filter fluid via the central conduit 533.

The filter head adapter 415 can include a plurality of apertures 536. For example, the endplate 502 defines a plurality of apertures 536 that extend therethrough. The apertures 536 can be positioned radially around the outer projection 530. The apertures 536 can be evenly spaced around the outer projection 530. Each of the apertures 536 can be configured to receive a fluid to enter the adapter cavity 516.

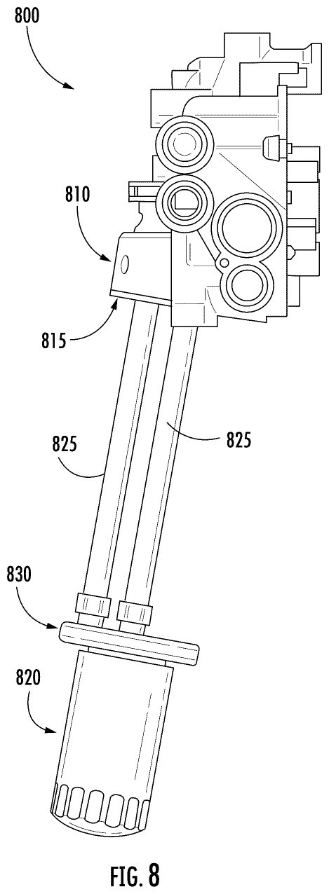

Referring to FIG. 8, an engine system 800 is shown, according to another example embodiment. The engine system 800 includes an engine (not shown). The engine can be an engine of a vehicle (e.g., car, truck, construction vehicle). The engine includes a filter head 810. The filter head 810 is configured to couple a filter element with the engine. The engine system 800 includes a filter head adapter 815. The filter head adapter 815 couples with the engine 805 via the filter head 810. The filter head adapter 815 provides a connection point for a filter element. The engine system 800 includes a filter element 820. The filter element 820 is configured to couple with the engine via the filter head adapter 815.

The filter element 820 is remote from the engine. For example, the engine system 800 includes at least one filter conduit 825. The filter conduit 825 extends between the filter head adapter 815 and the filter element 820 such that the filter element 820 can be positioned away from the engine and the filter head adapter 815.

In some embodiments, the filter conduit 825 can couple directly with the filter element 820. For example, a first end of the filter conduit 825 can couple with the filter head adapter 815 and a second end of the filter conduit 825 can couple with the filter element 820. In some embodiments, the filter conduit 825 can couple with a second adapter, shown as remote adapter 830. For example, the filter element 820 can couple with the remote adapter 830. The first end of the filter conduit 825 can couple with the filter head adapter 815 and the second end of the filter conduit 825 can couple with the remote adapter 830.

The engine system 800 includes a first filter conduit 825 and a second filter conduit 825. The first filter conduit 825 is an inlet filter conduit 825 and the second filter conduit 825 is an outlet filter conduit 825. Both filter conduits 825 extend between the filter head adapter 815 and the remote adapter 830.

The filter conduits 825 can be rigid or flexible. For example, a rigid filter conduit 825 can be a rigid pipe or tube that positions the filter element 820 at a specific location relative to the engine. A flexible filter conduit 825 can be a flexible hose or tubing that can be easily manipulated to position the filter element 820 at different locations relative to the engine.

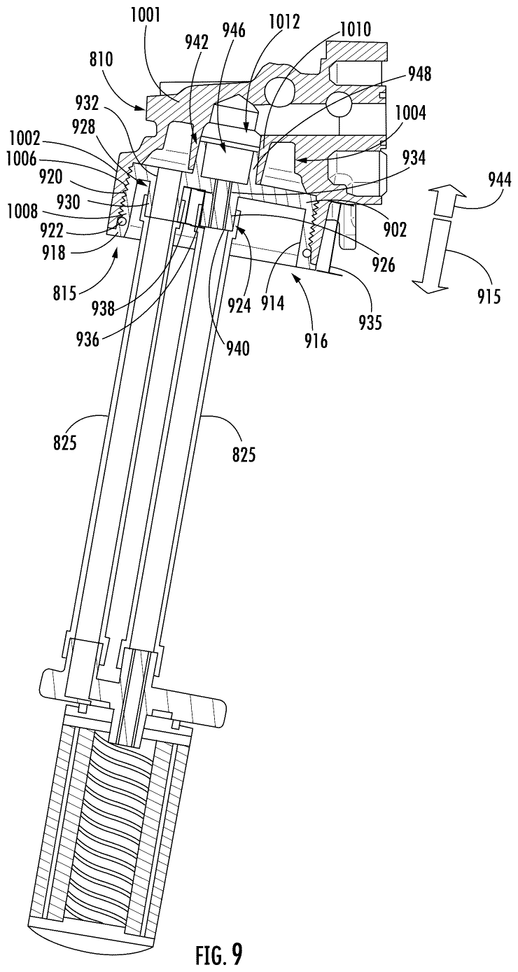

Referring to FIG. 9, a filter head adapter 815 is shown, according to an example embodiment. The filter head adapter 815 is configured to couple with the filter head 810. The filter head adapter 815 includes an endplate 902. The endplate 902 has an annular (e.g., disk) shape.

The filter head adapter 815 includes an outer wall 914. The outer wall 914 extends from an edge of the endplate 902 in a first direction 904. The outer wall 914 extends axially away from the endplate 902 at the edge of the endplate 902. The outer wall 914 extends along the entire edge (e.g., perimeter) of the endplate 902. The outer wall 914 and the endplate 902 define a cavity, shown as adapter cavity 916. The filter head adapter 815 includes a flange 918. The flange 918 is positioned at an end of the outer wall 914, opposite the endplate 902. The flange 918 extends radially outward from the end of the outer wall 914 (e.g., away from the adapter cavity 916).

The outer wall 914 includes a threaded portion, shown as outer threaded portion 920, comprising a plurality of threads. The outer threaded portion 920 is radially outwardly facing such that the threads are extending radially outward from the outer wall 914. The outer threaded portion 920 is radially external to (e.g., positioned outside of) the adapter cavity 916.

The outer threaded portion 920 is configured to couple the filter head adapter 815 with the filter head 810. For example, the filter head 810 comprises a head body 1001. The filter head 810 includes an outer head wall 1002. The outer head wall 1002 extends axially from the head body 1001. The head body 1001 and the outer head wall 1002 define a head cavity 1004. The outer head wall 1002 defines at least a portion of a side of the head cavity 1004. The outer head wall 1002 includes a threaded head portion 1006. The threaded head portion 1006 is configured to engage with the outer threaded portion 920 of the outer wall 914 to couple the filter head adapter 815 with the filter head 810. For example, the threaded head portion 1006 is positioned on an inner surface of the outer head wall 1002. The threaded head portion 1006 includes a plurality of threads that extend radially inward from the outer head wall 1002 into the head cavity 1004. The threaded head portion 1006 engages with the outer threaded portion 920 to couple the filter head adapter 815 with the filter head 810.

The outer wall 914 includes a seal element, shown as wall seal element 922. The wall seal element 922 is positioned on the outer wall 914. The wall seal element 922 is configured to form a radially outwardly directed seal with the filter head 810. For example, the outer head wall 1002 of the filter head 810 includes a flat portion 1008. The flat portion 1008 is positioned axially away from the head body 1001. For example, the threaded head portion 1006 is positioned axially between the flat portion 1008 and the head body 1001. The wall seal element 922 is configured to interface with the flat portion 1008 of the outer head wall 1002 to form a radial seal.

The wall seal element 922 is radially external to (e.g., positioned outside of) the adapter cavity 916. The wall seal element 922 is positioned axially between the outer threaded portion 920 and the flange 918. For example, the outer threaded portion 920 is positioned along the outer wall 914 closer to the endplate 902 than the wall seal element 922. In some embodiments, the wall seal element 922 includes a gasket (e.g., an O-ring).

The filter head adapter 815 includes a central protrusion 924. The central protrusion 924 extends axially away from the endplate 902 in the first direction 915. For example, the central protrusion 924 extends into the adapter cavity 916. The central protrusion 924 is positioned at a center of the endplate 902. For example, the central protrusion 924 is positioned at a center of the adapter cavity 916.

The central protrusion 924 includes a connection element, shown as central connection element 926. The central connection element 926 is configured to couple with a filter conduit 825. In some embodiments, the central connection element 926 can be a threaded feature comprising a plurality of threads. In some embodiments, the central connection element 926 can be a push-to-connect feature, among others. The central connection element 926 is configured to couple a filter element 820 with the filter head adapter 815 via a filter conduit 825. For example, a filter conduit 825 can have a connection element that corresponds to the central connection element 926. A first end of the filter conduit 825 can couple with the filter head adapter 815 via the central connection element 926. A second opposite end of the filter conduit 825 can couple with the filter element 820 or a remote adapter 830 that is coupled with the filter element 820.

In some embodiments, the central connection element 926 can be external to (e.g., positioned outside of) the central protrusion 924. For example, the central connection element 926 can be on an outer surface of the central protrusion 924 in the adapter cavity 916. In some embodiments, the central connection element 926 can be internal to (e.g., positioned inside of) the central protrusion 924. For example, the central connection element 926 can be on an inner surface of the central protrusion 924.

The filter head adapter 815 includes an offset protrusion 928. The offset protrusion 928 extends axially away from the endplate 902 in the first direction 915. For example, offset protrusion 928 extends axially into the adapter cavity 916. The offset protrusion 928 is positioned at a location offset from the center of the endplate 902. For example, the offset protrusion 928 is positioned in the adapter cavity 916 radially between the central protrusion 924 and the outer wall 914.

The offset protrusion 928 includes an offset connection element 930. The offset connection element 930 is configured to couple with a filter conduit 825. In some embodiments, the offset connection element 930 can be a threaded feature comprising a plurality of threads. In some embodiments, the offset connection element 930 can be a push-to-connect feature, among others. The offset connection element 930 is configured to couple a filter element 820 with the filter head adapter 815 via a filter conduit 825. For example, a filter conduit 825 can have a connection element that corresponds to the offset connection element 930. A first end of the filter conduit 825 can couple with the filter head adapter 815 via the offset connection element 930. A second opposite end of the filter conduit 825 can couple with the filter element 820 or a remote adapter 830 that is coupled with the filter element 820.

In some embodiments, the offset connection element 930 can be external to (e.g., positioned outside of) the offset protrusion 928. For example, the offset connection element 930 can be on an outer surface of the offset protrusion 928 in the adapter cavity 916. In some embodiments, the offset connection element 930 can be internal to (e.g., positioned inside of) the offset protrusion 928. For example, the offset connection element 930 can be on an inner surface of the offset protrusion 928.

The filter element 820 can be coupled with the filter head adapter 815 via the central protrusion 924 and the offset protrusion 928. For example, a first filter conduit 825 can couple with the offset protrusion 928 and a second filter conduit 825 can couple with the central protrusion 924. The first and second filter conduits 825 can couple with the filter element 820, or a remote adapter 830 coupled thereto.

The filter head adapter 815 includes at least one conduit. For example, the endplate 902 and the offset protrusion 928 define a first conduit, shown as offset conduit 932, that extends therethrough. The offset conduit 932 is configured to be a fluid inlet such that fluid can enter the filter element 820 via the offset conduit 932. For example, the fluid enters the offset conduit and flows through a first filter conduit 825 to enter the filter element 820.

The endplate 902 and the central protrusion 924 define a second conduit, shown as central conduit 934, that extends therethrough. The central conduit 934 is configured to be a fluid outlet such that fluid can exit the filter element 820 via the central conduit 934. For example, the fluid flows from the filter element 820 through a second filter conduit 825 and out through the central conduit 934.

The outer wall 914 has a first length, shown as outer wall length 935. The central protrusion 924 has a second length, shown as central length 936. The offset protrusion 928 has a third length, shown as offset length 938. In some embodiments, the outer wall length 935 is greater than the central length 936. In some embodiments, the outer wall length 935 is greater than the offset length 938 and the central length 936. In some embodiments, the outer wall length 935 is less than the central length 936 and the offset length 938. In some embodiments, the central length 936 and the offset length 938 are the same length. In some embodiments, the central length 936 and the offset length 938 are different lengths. In some embodiments, the central length 936 is greater than the outer wall length 935. In some embodiments, the offset length 938 is greater than the outer wall length 935.

The filter head adapter 815 includes an installation element 940. The installation element 940 is configured to facilitate installation of the filter head adapter 815 with a filter head 810. The installation element 940 is a part of the central protrusion 924. For example, the installation element 940 can define a cavity that extends at least partially axially through the central protrusion 924. The cavity can be the installation element 940. For example, the installation element 940 or cavity can have a specific shape. A tool can have a feature that corresponds to the installation element 940 to allow the tool to grip the filter head adapter 815 to couple the filter head adapter 815 with the filter head 810. The installation element 940 can have any shape. For example, the installation element 940 can have a square shape such that the cavity of the central protrusion 524 has a square cross-sectional shape.

The filter head adapter 815 includes an outer projection 942. The outer projection 942 extends axially away from the endplate 902 in a second direction 944. The second direction 944 is opposite the first direction 915 of the central protrusion 924. The offset protrusion 928 is positioned radially between the outer wall 914 and the outer projection 942. The outer projection 942 has a diameter that is greater than a diameter of the central protrusion 924. The central protrusion 924, the endplate 902, and the outer projection 942 define a central conduit 946 that extends therethrough. The central conduit 946 has a first portion with a first diameter or cross-sectional area that extends axially through the outer projection 942 and a second portion with a second diameter or cross-sectional area that extends axially through the endplate 902 and the central protrusion 924. The first diameter or cross-sectional area is greater than the second diameter or cross-sectional area. The second portion of the central conduit 946 can be or include the installation element 940. For example, a shape of the second portion of the central conduit 946 can correspond with a shape of a tool configured to help couple the filter head adapter 815 with the filter head 810.

The outer projection 942 includes a seal element, shown as projection seal element 948. The projection seal element 948 is positioned on an outer surface of the outer projection 942. The projection seal element 948 is configured to form a radially outwardly directed seal with the filter head 810. For example, the filter head 810 includes an inner head wall 1010. The inner head wall 1010 extends axially from the head body 1001 into the head cavity 1004. The inner head wall 1010 defines an inner head cavity 1012. The outer projection 942 can be positioned in the inner head cavity 1012. The projection seal element 948 is configured to interface with an inner surface of the inner head wall 1010 to form a radial seal. The wall seal element 922 can form a first seal with the filter head 810 and the projection seal element 948 can form a second seal with the filter head 810.

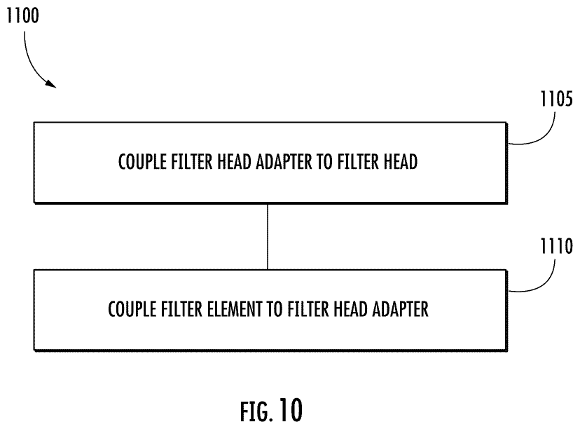

Referring to FIG. 10, a method 1100 for installing a filter element is shown, according to an example embodiment. Method 1100 includes coupling a filter head adapter to a filter head (process 1105). For example, process 1105 can include coupling a filter head adapter 115, 415, 815 to a filter head 110, 410, 810.

In some embodiments, process 1105 includes positioning a filter head adapter 115 in a filter head 110. For example, at least a portion of the filter head adapter 115 can be positioned in the head cavity 304. With the filter head adapter 115 in the head cavity 304, the filter head adapter 115 can couple with the filter head 110 and form at least one seal with the filter head 110. For example, the outer threaded portion 220 of the filter head adapter 115 can engage with the threaded head portion 306 of the filter head 110 to couple the filter head adapter 115 to the filter head 110. The wall seal element 222 of the filter head adapter 115 can interface with the flat portion 308 of the filter head 110 to form a first seal. The first seal can be a radial seal.

With the filter head adapter 115 in the head cavity 304, the second portion 208 of the central conduit 204 can be disposed in the inner head cavity 312. The conduit seal element 223 of the filter head adapter 115 can interface with the inner head wall 310 of the filter head 110 to form a second seal. The second seal can be a radial seal.

In some embodiments, process 1105 includes positioning a filter head adapter 415 in a filter head 410. For example, at least a portion of the filter head adapter 415 can be positioned in the head cavity 604. With the filter head adapter 415 in the head cavity 604, the filter head adapter 415 can couple with the filter head 410 and form at least one seal with the filter head 410. For example, the outer threaded portion 520 of the filter head adapter 415 can engage with the threaded head portion 606 of the filter head 410 to couple the filter head adapter 415 to the filter head 410. The wall seal element 522 of the filter head adapter 415 can interface with the flat portion 608 of the filter head 410 to form a first seal. The first seal can be a radial seal.

With the filter head adapter 415 in the head cavity 604, the outer projection 530 can be disposed in the inner head cavity 612. The projection seal element 534 of the filter head adapter 415 can interface with the inner head wall 610 of the filter head 410 to form a second seal. The second seal can be a radial seal.

In some embodiments, process 1105 includes positioning a filter head adapter 815 in a filter head 810. For example, at least a portion of the filter head adapter 815 can be positioned in the head cavity 1004. With the filter head adapter 815 in the head cavity 1004, the filter head adapter 815 can couple with the filter head 810 and form at least one seal with the filter head 810. For example, the outer threaded portion 920 of the filter head adapter 815 can engage with the threaded head portion 1006 of the filter head 810 to couple the filter head adapter 815 to the filter head 810. The wall seal element 922 of the filter head adapter 815 can interface with the flat portion 1008 of the filter head 810 to form a first seal. The first seal can be a radial seal.

With the filter head adapter 815 in the head cavity 1004, the outer projection 942 can be disposed in the inner head cavity 1012. The projection seal element 948 of the filter head adapter 815 can interface with the inner head wall 1010 of the filter head 810 to form a second seal. The second seal can be a radial seal.

Method 1100 includes coupling a filter element to a filter head adapter (process 1110). In some embodiments, process 1110 includes directly coupling the filter element to the filter head adapter. For example, filter element 120 can directly couple with filter head adapter 115. At least a portion of the filter element 120 can be positioned in the adapter cavity 216. For example, an end of the filter element 120 can be positioned in the adapter cavity 216. The filter element 120 can have a filter projection 314 that extends from the end of the filter element 120 and into the wall cavity 236 of the filter head adapter 115. The filter projection 314 can include a threaded filter portion 316 that is configured to engage the inner threaded portion 226 of the filter head adapter 115 to couple the filter element 120 with the filter head adapter 115.

With the filter element 120 coupled with the filter head adapter 115, the filter element 120 can form a seal with the filter head adapter 115. For example, the filter projection 314 can include a filter seal element 318. The filter seal element 318 can interface with the seal member 238 of the filter head adapter 115 to form an axial seal between the filter element 120 and the endplate 202 of the filter head adapter 115. In some embodiments, the filter seal element 318 can interface with the seal member 238 of the filter head adapter 115 to form a radial seal between the filter element 120 and the filter head adapter 115.

As another example, filter element 420 can directly couple to filter head adapter 415. At least a portion of the filter element 420 can be positioned in the adapter cavity 516. For example, an end of the filter element 420 can be positioned in the adapter cavity 516. The filter element 420 can have a threaded filter portion 616 that is configured to engage the inner threaded portion 526 of the filter head adapter 415 to couple the filter element 420 with the filter head adapter 415.

With the filter element 420 coupled with the filter head adapter 415, the filter element 420 can form a seal with the filter head adapter 415. For example, the filter element 420 can include a filter seal element 618. The filter seal element 618 can interface with the endplate 502 of the filter head adapter 115 to form an axial seal between the filter element 420 and the endplate 502 of the filter head adapter 415.

In some embodiments, process 1110 includes indirectly coupling the filter element to the filter head adapter. For example, one or more intermediate components can be positioned between the filter element and the filter head adapter. For example, filter element 820 can indirectly couple with the filter head adapter 815. At least one filter conduit 825 can extend between the filter head adapter 815 and the filter element 820 such that the filter element 820 can be positioned away from the filter head adapter 815. For example, a first filter conduit 825 can be coupled with the central protrusion 924 of the filter head adapter 815. A first end of the first filter conduit 825 can couple with the central protrusion 924 via the central connection element 926 and a second end of the first filter conduit 825 can couple with the filter element 820, or a corresponding remote adapter 830. A second filter conduit 825 can couple with the offset protrusion 928 via the offset connection element 930. A first end of the second filter conduit 825 can couple with the offset protrusion 928 and a second end of the second filter conduit 825 can couple with the filter element 820, or the corresponding remote adapter 830.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various example embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A filter head adapter, comprising:
an endplate;
a central conduit comprising a first portion and a second portion, the first portion extending in a first direction from the endplate and the second portion extending in a second direction from the endplate;
an outer wall extending from an edge of the endplate in the first direction, the outer wall comprising a first threaded portion; and
an inner wall extending from the endplate in the first direction, the inner wall comprising a second threaded portion;
wherein:
the outer wall and the endplate define a cavity; and
the inner wall is positioned in the cavity between the outer wall and the first portion of the central conduit.

2. The filter head adapter of claim 1, wherein the outer wall has a first length and the inner wall has a second length, the first length greater than the second length.

3. The filter head adapter of claim 2, wherein the first portion of the central conduit has a third length, the third length greater than the first length and the second length.

4. The filter head adapter of claim 1, wherein the endplate defines a plurality of apertures extending therethrough, the plurality of apertures positioned radially between the central conduit and the inner wall.

5. The filter head adapter of claim 1, wherein the outer wall and the inner wall define a wall cavity therebetween, the filter head adapter further comprising:
a seal member positioned in the wall cavity, the seal member interfacing with the endplate and configured to form a seal between the filter head adapter and a filter element coupled with the filter head adapter.

6. The filter head adapter of claim 1, wherein the first threaded portion and the second threaded portion are radially outwardly facing.

7. The filter head adapter of claim 1, further comprising:
a first seal element positioned on the outer wall and configured to form a first seal with an filter head; and
a second seal element positioned on the second portion of the central conduit, the second seal element configured to form a second seal with the filter head.

8. The filter head adapter of claim 1, further comprising:
an installation element positioned at a base of the first portion of the central conduit adjacent to the endplate, the installation element radially external to the central conduit.

9. A filter head adapter, comprising:
an endplate;
an outer wall extending from an edge of the endplate in a first direction, the outer wall comprising a threaded portion, wherein the endplate and the outer wall define a cavity;
a central protrusion extending from the endplate in the first direction into the cavity, the central protrusion comprising:
an internal installation element configured to facilitate installation of the filter head adapter with a filter head; and
an outer projection extending from the endplate in a second direction;
wherein the central protrusion, the endplate, and the outer projection define a central conduit that extends therethrough.

10. The filter head adapter of claim 9, wherein the outer wall has a first length and the central protrusion has a second length, the first length greater than the second length.

11. The filter head adapter of claim 10, further comprising:
an offset protrusion extending from the endplate in the first direction into the cavity, the offset protrusion positioned radially between the central protrusion and the outer wall.

12. The filter head adapter of claim 11, wherein the offset protrusion has a third length, the third length less than the first length.

13. The filter head adapter of claim 9, wherein the endplate defines a plurality of apertures that extend therethrough, the plurality of apertures positioned radially between the outer projection and the outer wall.

14. The filter head adapter of claim 13, wherein the outer projection has a greater diameter than the central protrusion.

15. The filter head adapter of claim 9, wherein:
the threaded portion is a first threaded portion; and
the central protrusion comprises a second threaded portion, the second threaded portion comprising threads that extend radially outward from the central protrusion, the second threaded portion configured to couple a filter element with the filter head adapter.

16. The filter head adapter of claim 9, further comprising:
a first seal element positioned on the outer wall to form a first seal with the filter head; and
a second seal element positioned on the outer projection to form a second seal with the filter head.

17. The filter head adapter of claim 9, further comprising:
an offset protrusion extending from the endplate in the first direction into the cavity, the offset protrusion positioned radially between the central protrusion and the outer wall, the offset protrusion comprising a first connection element configured to couple with a first conduit; and
the central protrusion comprising a second connection element configured to couple with a second conduit.

18. A system, comprising:
a filter head;
the filter head adapter of claim 1; and
a filter element.

19. The system of claim 18, wherein the outer wall has a first length and the inner wall has a second length, the first length greater than the second length.

20. The system of claim 18, wherein the endplate defines a plurality of apertures extending therethrough, the plurality of apertures positioned radially between the central conduit and the inner wall.
